(19) United States
(12) Patent Application Publication
(10) Pub. No.: US 2025/0376373 A1
(43) Pub. Date: Dec. 11, 2025

(54) METHODS AND EQUIPMENT FOR CRYOGENIC REMOVAL OF IMPURITIES FROM OXYGEN GAS

(71) Applicant: ENTEGRIS, INC., Billerica, MA (US)

(72) Inventors: Sarah Vogt, Grover Beach, CA (US); Matthew Browning, San Luis Obispo, CA (US); Marco Holzner, Morro Bay, CA (US); Rocky D. Gipson, Arroyo Grande, CA (US)

(21) Appl. No.: 18/877,946

(22) PCT Filed: Jun. 30, 2023
(86) PCT No.: PCT/US2023/026781

§ 371 Date: Dec. 20, 2024

Related U.S. Application Data
(60) Provisional application No. 63/359,241, filed on Jul. 8, 2022.

(51) Int. Cl. C01B 13/02; B01D 53/04; C01B 5/00

(52) U.S. Cl. CPC C01B 13/0266; B01D 53/0407; B01D 53/0454; C01B 5/00; C01B 13/027; B01D 2257/102; B01D 2257/40

(57) ABSTRACT

Described are processes and equipment that are useful to produce purified oxygen gas using a cryogenic adsorption bed to remove impurities such as nitrogen-containing impurities (e.g., nitrogen (N₂), nitrogen oxides, ammonia, amines), water, carbon dioxide, carbon monoxide, hydrocarbons, among others, from oxygen gas.

### FIELD

This description relates to processes and equipment that are useful to produce purified oxygen gas using a cryogenic adsorption bed to remove impurities such as nitrogen-containing impurities (e.g., nitrogen (N₂) and nitrogen oxides), water, carbon dioxide, among others, from the oxygen gas.

### BACKGROUND

Oxygen is basic chemical element, and in purified forms is used for countless commercial processes.

In one use, oxygen is a raw material for preparing ozone for commercial processing, such as in manufacturing semiconductor and microelectronic devices. For these commercial applications, the ozone must have extremely high purity, which requires very high purity oxygen for use in preparing the ozone. To prepare ozone that has a purity level to be useful in manufacturing semiconductor and microelectronic devices, a source of oxygen used to prepare the ozone should be at a high range of purity levels of commercial oxygen gas. For these purposes, a raw material oxygen gas for preparing the ozone should have a purity of at least 99.9 percent oxygen, such as 99.995 percent oxygen, which is designated as Oxygen 4.5.

In processes of manufacturing semiconductor and microelectronic devices, oxygen is also used for forming oxide layers. Again, the oxygen used to form the oxide layer must be of very high purity. Nitrogen as a contaminant in oxygen that is used to form an oxide layer can be particularly disruptive to the quality of the prepared oxide layer. When nitrogen is present as a contaminant in oxygen that is used to form an oxide film, the nitrogen can form a nitride on the surface instead of the desired oxide. The nitride compound at the surface can change important physical or electrical properties of the deposited oxide film, e.g., by changing conductivity or resistivity of the film. The presence of nitrogen and nitrogen contaminants in oxygen gas used for forming oxides on semiconductor and microelectronic devices is very carefully controlled and monitored.

Currently, most commercial purified oxygen products are prepared by cryogenic distillation techniques.

### SUMMARY

Described are novel processes, systems, and equipment that can be used to produce purified oxygen gas by cryogenic adsorption methods that remove one or more impurities from an oxygen gas. The impurity may be a nitrogen-containing impurity such as nitrogen (N₂) or a nitrogen oxide, or may be water, carbon dioxide, carbon monoxide, or other type of impurity contained in the oxygen gas. The process can be used to remove an impurity from oxygen gas that has already been processed and purified to have a very high level of purity, e.g., a purity of at least 99.9 or greater (less than 0.1 percent total impurities). Examples of the described methods can be useful to efficiently produce purified oxygen that has a lower level of impurities than oxygen that is prepared by cryogenic distillation techniques that are presently used commercially.

Example methods and systems can be useful to remove a significant amount of impurities initially present in gaseous oxygen (i.e., “oxygen gas”). The oxygen gas can have various impurities, which include one or more nitrogen-containing impurities (e.g., N₂, or a nitrogen oxide, or both), possibly in combination with one or more of hydrogen, argon, water, carbon dioxide, hydrocarbons, and carbon monoxide. The impurities are removed by cryogenically causing the impurities to become adsorbed at surfaces of adsorbent media, while preventing the oxygen from being condensed during the cryogenic process. To prevent oxygen from condensing, the system includes a temperature control system that monitors a temperature within the cryogenic adsorption bed and controls the temperature to a setpoint above a condensation temperature of the gaseous oxygen.

In one aspect, the disclosure relates to a method of purifying oxygen gas to form purified oxygen gas. The method includes: contacting the oxygen gas with adsorption media at a temperature below −100 degrees Celsius to cause a nitrogen-containing impurity and optionally other impurities that are contained in the oxygen gas to adsorb onto a surface of the adsorption media, without allowing oxygen to condense.

In another aspect, the disclosure relates to a system for removing impurities from oxygen gas. The system includes: a source of oxygen gas; a cryogenic adsorption bed connected to the source of oxygen gas, the cryogenic adsorption bed containing adsorbent particles held at a cryogenic temperature and adapted to adsorb a nitrogen-containing impurity that is contained in the oxygen gas without causing oxygen to condense; and a temperature control system that controls the temperature to a setpoint above a condensation temperature of the gaseous oxygen.

### BRIEF DESCRIPTION OF THE DRAWINGS

FIG. 1 shows a schematic version of an exemplary process and an exemplary system as described.

### DETAILED DESCRIPTION

Described are novel processes and equipment that can be used to produce purified oxygen gas by a cryogenic adsorption method. The method can be effective to remove a nitrogen-containing impurity such as nitrogen (N₂) or a nitrogen oxide (e.g., N₂O, NO, NO₂), as well as water, carbon monoxide, carbon dioxide, hydrocarbons, among others, from the oxygen gas by reducing the temperature of the oxygen gas to a cryogenic temperature at which an impurity adsorbs onto a surface of an adsorbent, but without also allowing the oxygen to condense. The method can be used to remove gaseous impurities from oxygen gas that has already been processed and purified to have a very high level of purity, e.g., a purity of at least 99.9 or greater.

The process and equipment used for the process are designed to remove the impurities by causing the impurities to adsorb onto a surface of an adsorbent, while at the same time preventing oxygen from being condensed. The equipment includes a control system that prevents a cryogenic cooling system from reducing a temperature of the cryogenic adsorption process to a temperature that is sufficiently low to cause oxygen to condense. The control system may be programmed to include a “minimum temperature setpoint” (“setpoint” for short), which is a temperature that is approximately equal to or slightly above the condensation point of oxygen within the process, at the processing pressure. If the control system senses a temperature that is equal to the minimum temperature setpoint, the cryogenic cooling system suspends additional cooling and allows the temperature to increase.

Oxygen gas that contains various types and amounts of impurities is commercially available as a gaseous raw material. Examples of specifications for oxygen gas as a raw material include the following.

TABLE 1

| | Oxygen HC- | | | | |
|---|---|---|---|---|---|
| | Free | Oxygen 4.5 | Oxygen 5.0 | Oxygen 5.6 | Oxygen 6.0 |
| Oxygen purity | ≥99.6 | ≥99.995 | ≥99.999 | ≥99.9996 | ≥99.9999 |
| (percent) | | | | | |
| N₂ (ppm) | ≤4000 total | ≤20 | ≤5 | ≤2 | ≤0.5 |
| Ar (ppm) | N₂ and Ar | ≤10 | ≤2 | ≤1 | ≤1 |
| H₂O (ppm) | ≤5 | ≤5 | ≤3 | ≤1 | ≤0.5 |
| CO₂ (ppm) | ≤1 | ≤0.5 | ≤0.2 | ≤0.1 | ≤0.1 |
| CₙHₘ (ppm) | ≤0.1 | ≤0.5 | ≤0.2 | ≤0.1 | ≤0.1 |
| CO (ppm) | | | | ≤0.1 | ≤0.1 |

As shown at Table 1, examples of different classifications of oxygen gases having different purity levels and different impurity types are available as: “Oxygen 4.5,” having an at least a 99.995 percent oxygen purity level, “Oxygen 5.0,” having an at least 99.999 percent oxygen purity level; “Oxygen 5.6,” having an at least 99.9996 percent oxygen purity level; and “Oxygen 6.0,” having an at least 99.9999 percent oxygen purity level. These and other versions of purified oxygen gases may contain impurities that include hydrogen (H₂), nitrogen (N₂), argon (Ar), water (H₂O), carbon dioxide (CO₂), hydrocarbons (CₙHₘ), or other types of molecular contaminants.

An oxygen gas for processing as described can have levels and types of impurities as presented, but may also contain different types of impurities, higher levels of any one of these impurities, or both. Examples of other impurities include nitrogen or nitrogen oxides (e.g., N₂O, NO, NO₂), ammonia (NH₃), amines, among others. Herein, nitrogen (N₂), nitrogen oxides, ammonia, amines, and other nitrogen-containing compounds that are impurities in an oxygen gas may be referred to collectively as “nitrogen-containing impurities.” Also, an oxygen gas as processed herein may include a higher amount of any of these listed impurities, e.g., water in an amount up to (e.g., less than) 10, 20, or 30 ppm.

An amount of an impurity in an oxygen gas may be described as a percentage, or alternately in terms of parts per million or parts per billion. The terms “parts per million” and “parts per billion” are used herein in a manner that is consistent with the use of these terms in the chemical arts, including in the arts of manufacturing microelectronic and semiconductor devices. In this respect, parts per million (“ppm”) is commonly used as a dimensionless measure of small levels (concentrations) of an impurity in a gas, expressed as milligrams contaminant per liter fluid (mg/L), and measures the mass of the contaminant per volume of the fluid. One part per million is equal 1×10⁻⁶ or 0.0001% of a total substance. One part per billion (“ppb”) is equal to 1×10⁻⁹ or 0.0000001% of a total substance.

The term “oxygen gas” used herein refers to a source or flow of oxygen gas that is used in a process as described, by which impurities are removed from the oxygen gas using a cryogenic adsorption step. The present description uses the term “oxygen gas” to refer to an oxygen-containing gas that is used according to a process as described, and allows for various different forms of the gas at different stages of the process. “Oxygen gas” includes oxygen gas as a raw material (before any processing), as well as various forms that the oxygen gas will have as the oxygen gas is processed by one or more steps that occur before a cryogenic adsorption step, such as: during and after a step of converting hydrogen within the oxygen gas to water by catalysis, and a step of cooling or “pre-cooling” the oxygen gas, each optionally being performed before a step of purifying the oxygen gas using a cryogenic adsorption bed. After the oxygen gas has been processed by the cryogenic purifier to reduce an amount of one or more impurities in the oxygen gas, the oxygen gas may be referred to as “purified oxygen” or “purified oxygen gas.”

According to the present description, an oxygen gas that is purified by a cryogenic adsorption step begins as an oxygen gas that has a high level of purity, but that also contains some level of impurity that can be removed by a cryogenic adsorption step. In a cryogenic adsorption step, the oxygen gas that contains the impurity is flowed to contact an adsorbent at a cryogenic temperature, such as below −100 degrees Celsius. Impurities that are contained in the oxygen gas are removed from the flow of the oxygen gas by being adsorbed onto surfaces of the adsorbent.

The oxygen gas is flowed to contact the solid adsorbent material to cause impurities that are present in the oxygen gas to be attracted to and adsorbed onto surfaces of the adsorbent, to remove the impurities from the flow of oxygen gas. Oxygen gas in the flow does not become adsorbed on the surfaces of the adsorbent in a significant amount but flows past the adsorbent surfaces. Also according to the described methods, oxygen does not otherwise condense when the oxygen gas flows past the adsorbent surfaces.

To prevent oxygen in the flow of oxygen gas from condensing on the adsorbent during the cryogenic adsorption step, the temperature of the oxygen, the temperature of the adsorbent, or both, is maintained at a temperature that is higher than a temperature at which the gaseous oxygen, at the pressure experienced during the cryogenic adsorption step, will condense.

In example systems, a cryogenic adsorption bed includes a temperature control system that includes one or more temperature sensors and an electronic (computerized) control device that electronically controls a temperature of a cryogenic adsorption process at a temperature above a condensation temperature of the oxygen flowing through the cryogenic adsorption bed. For example, a temperature control system can be used to control a temperature of oxygen gas such that the temperature of the oxygen gas does not fall below a preset minimum level, i.e., a “setpoint” of −180 degrees Celsius, −185 degrees Celsius, or −190 degrees Celsius.

Example temperature control systems can include at least a computerized hardware processor, and memory operatively connected to the processor. The memory can store instructions to be executed at the processor. Also provided is at least one temperature sensor operatively connected to the processor, to measure one or more temperatures of the oxygen, adsorbent, or other component of the cryogenic adsorption process. Examples of the temperature sensor can include a thermistor, a negative temperature coefficient sensor, an infrared temperature sensor, a thermocouple, or any other type of temperature sensor that is available and known for measuring a temperature in a cryogenic temperature range. Optionally and in various example systems of this description a temperature control system can include, as a computer processor, a microprocessor of any form, e.g., as a process logic controller (PLC controller) embodied in an application-specific integrated circuit (ASIC), or the like.

The processor is adapted to execute instructions stored by the memory such that various temperature control functions or methods can be carried out, including to establish and monitor temperature of the system relative to a minimum temperature setpoint, which is a minimum allowed temperature of the adsorption bed and oxygen passing through the adsorption bed. In various embodiments, the temperature control system can be configured to dynamically (continuously, or at various intervals) measure a temperature at the adsorption bed using the temperature sensor, and optionally output a signal to one or more components of the cooling system such that further cooling of the cryogenic adsorption bed or a component thereof is halted, to prevent the cryogenic adsorption bed from reaching a temperature that is below the minimum temperature threshold or “setpoint.”

A cryogenic adsorption step is a step of contacting a flow of oxygen gas with solid adsorption media at a cryogenic temperature that will cause impurities in the oxygen gas to become adsorbed onto surfaces of the adsorption media. According to the present description, the oxygen gas does not adsorb on the surfaces of the adsorption media, and also does not otherwise condense during the cryogenic adsorption step. The cryogenic adsorption step is performed using a cryogenic adsorption apparatus, which includes a process chamber (a.k.a., an “adsorption chamber”) that includes an interior volume that contains adsorbent, and a cryogenic cooling system. The cooling system controls the temperature within the chamber interior, along with the temperature of the oxygen gas that flows through the chamber interior and the adsorbent that is contained in the chamber interior.

The equipment is adapted to perform the cryogenic adsorption step in a manner that removes impurities from the oxygen gas without allowing or causing oxygen to condense within the adsorption chamber. The cryogenic adsorption apparatus includes a control system that prevents the cryogenic cooling system from reaching a temperature at which oxygen will condense. The control system is programmed to include a “setpoint” temperature that is approximately equal to or slightly above the temperature at which oxygen would condense within the chamber interior. During the cryogenic adsorption step, if the control system senses a temperature within the cryogenic adsorption apparatus (e.g., of the oxygen gas or the adsorbent) that is equal to the temperature setpoint, the cryogenic cooling system does not provide any additional cooling to the cryogenic adsorption apparatus (e.g., oxygen gas or adsorbent), and the temperature is allowed to gradually increase.

During the purification process, the oxygen gas that contains an impurity can be flowed through the adsorption chamber to contact the adsorption media. When the oxygen gas contacts the adsorption media, an amount of impurity in the oxygen gas adsorbs onto the adsorption media and the impurity is removed from the oxygen gas. The impurity may be adsorbed at an adsorbent surface at an exterior location of an adsorbent, or at a surface within a pore of the adsorbent, by a physical adsorption or “physisorption” mechanism.

A variety of useful adsorbent media materials are known. Examples of useful adsorbents that are known to be useful to adsorb impurities from a flow of gas include: activated carbon (including carbon molecular sieves), zeolite materials, metal organic framework adsorbents (“MOFs”), zeolitic imidazolate framework adsorbents (“ZIFs”), and zeolite templated carbon adsorbents (ZTCs).

Useful types of adsorption media include those with pore sizes on an angstrom scale, which may be referred to as “molecular sieves.” Example adsorbents of a type useful as a “molecular sieve” can be characterized based on pore size (diameter). Molecular sieve adsorption media may have a pore size in a range of angstroms, e.g., less than 20 angstroms. Molecular sieves with pore sizes of 10 angstroms, 8 angstroms, or 5, 4, or 3 angstroms, are available commercially.

An adsorption media (or “adsorbent” for short) may also be described in terms of surface area. A useful adsorbent may have any useful surface area, with a higher surface area adsorbent sometimes being preferred. Very generally, useful adsorbents may have a surface area in a range from 100 square centimeters per gram to several thousand square centimeter per gram. Zeolite adsorbents may have surface areas at a lower end of this range, e.g., from 100 to 1500 square centimeters per gram. Other types of adsorbents may have significantly higher surface areas, e.g., some MOFs and ZIFs have surface areas up to 5,000, 6,000, or 7,000 square centimeters per gram.

The adsorbent can be in any of various sizes and shapes, such as small particulates, granules, pellets, shells, cubes, which may be in the form of fine particles to form a powder.

Example adsorbents that have been identified as useful in a cryogenic adsorption step as described, to adsorb impurities from oxygen gas at a cryogenic temperature, include molecular sieve adsorbents include activated carbon and zeolite materials having pore sizes associated with a molecular sieve.

One type of useful adsorbent is the type of crystalline alumino-silicates known as “zeolites.” Zeolites include synthetic hydrated aluminosilicate, and natural zeolite that has the function of screening molecules. A zeolite structure has many neatly arranged pores with relatively uniform pore size.

Zeolite adsorbents are made of a three dimensional interconnecting network of alumina and silica tetrahedra, which form a porous solid. The structure allows the natural water of crystallization to be removed, leaving a porous crystalline structure. Zeolites are crystalline microporous materials primarily made up of SiO₄ and AlO₄ corner-sharing tetrahedral building units. These are grown to form three-dimensional (3D) crystalline frameworks with well-defined channels and cavities of molecular dimensions. The pores or “cages” have a high affinity to re-adsorb water or other molecules of a specific size which is aided by strong ionic forces due to the presence of cations such as sodium, calcium, and potassium and by a high internal surface area. Highly electropositive cations such as sodium, potassium, and calcium present in the structure can increase the polarity of these sieves.

Examples of synthetic zeolites include “Type-A” zeolites and “Type-X” zeolites, with a range of pore sizes and chemical varieties of each type. In conventional forms, a zeolite molecular sieve product may be in the form of beads, pellets, or powder, or porous particles, and can be characterized based on pore size (diameter). The zeolites be characterized as having pore size in a range of angstroms, e.g., less than 20 angstroms, such as 10 angstroms, 8 angstroms, or 5, 4, or 3 angstroms, are available commercially.

Examples of commercially available molecular sieve products include the following types based on pore size and chemistry. A “4 A” type sieve (Na₂O·Al₂O₃·2SiO₂·9/2H₂O) has a continuous three-dimensional network of channels approximately 4 A in diameter, in addition to larger “cages” approximately 7 Å in diameter. The “3 A” molecular sieve (⅔K₂O·⅓Na₂₂O·Al₂O₃·2SiO₂·9/2 H₂O) is made by substituting potassium cations for the inherent sodium ions of the 4 A base structure, and has a nominal pore size of three angstroms (3 Å).

The “5 A” type sieve (¾CaO·¼Na₂O·Al₂O₃·2SiO₂·9/2H₂O) is described as a three-dimensional network of intersecting channels with calcium substituted for potassium cations. Entry to the channels is restricted by the eight oxygen atoms from which they are formed (approx. 3-5 Å diameter). Where these channels intersect, larger pores or cages with diameters of 11.4 Å are formed.

A “13X” type sieve has an effective pore size of ten angstroms (10 Å), and is formed by Na₂O·Al₂O₃·(2.8±0.2)SiO₂·(6-7)H₂O.

Also useful as an adsorbent in the cryogenic adsorption step are “carbon adsorbents,” which refer to a range of carbon-based materials that are derived synthetically from carbon-containing polymeric materials or from carbon-based materials having a natural source. Examples include: carbon formed by pyrolysis of synthetic hydrocarbon resins such as polyacrylonitrile, sulfonated polystryrene-divinylbenzene, polyvinylidene chloride, etc.; cellulosic char; charcoal; and activated carbon formed from natural source materials such as coconut shells, pitch, wood, petroleum, coal; nanoporous carbon, etc.

Carbon adsorbent (as well as other types of adsorbents) may have any suitable form, such as a form of granules (also referred to as “particles”). Granules are individual pieces of carbon adsorbent, each piece having a relatively small size, such as less than 2 centimeters, or less than 1 or 0.5 centimeter. The particles may have any useful particle size, shape, and range of particle sizes. Examples shapes include beads, granules, pellets, tablets, shells, saddles, powders, irregularly-shaped particulates, extrudates of any shape and size, cloth or web form materials, and composites (of the adsorbent with other components), as well as comminuted or crushed forms of the foregoing types of adsorbent materials.

An adsorbent may also be of a type referred to as a carbon molecular sieve (“CMS”). Carbon molecular sieves are available commercially and are prepared generally by pyrolysis or carbonization of polymeric precursors under a controlled vacuum or inert atmosphere.

Also useful as an adsorbent in a cryogenic adsorption process as described may be zeolitic materials, which include zeolitic imidazolate framework adsorbent. Zeolitic imidazolate frameworks adsorbents are metal organic frameworks that include a tetrahedrally-coordinated transition metal such as iron (Fe), cobalt (Co), Copper (Cu), or Zinc (Zn), connected by imidazolate linkers, which may be the same or different within a particular ZIF composition or relative to a single transition metal atom of a ZIF structure. The ZIF structure includes four-coordinated transition metals linked through imidazolate units to produce extended frameworks based on tetrahedral topologies. ZIFs are said to form structural topologies that are equivalent to those found in zeolites and other inorganic microporous oxide materials.

A zeolitic imidazolate framework can be characterized by features that include: a particular transition metal (e.g., iron, cobalt, copper, or zinc) of the framework; the chemistry of the linker (e.g., chemical substituents of the imidazolate units); pore size of the ZIF; surface area of the ZIF; pore volume of the ZIF; among other physical and chemical properties. Dozens (at least 105) of unique ZIF species or structures are known, each having a different chemical structure based on the type of transition metal and the type of linker (or linkers) that make up the framework. Each topology is identified using a unique ZIF designation, e.g., ZIF-1 through ZIF-105. For a description of ZIFs, including particular chemical compositions and related properties of a large number of known ZIF species, see Phan et al., “Synthesis, Structure, and Carbon Dioxide Capture Properties of Zeolitic Imidazolate Frameworks,” Accounts of Chemical Research, 2010, 43 (1), pp 58-67 (Received Apr. 6, 2009).

Pore size of a ZIF can affect the performance of a ZIF as an adsorbent. Example ZIFs can have pore sizes in a range from about 0.2 to 13 angstroms, such as from 2 to 12 angstroms or from 3 to 10 angstroms.

As another example, a useful adsorbent may be of a type referred to as a zeolite-templated carbon adsorbent (“ZTC”). Zeolite-templated carbons (ZTCs) contain ordered microporous carbon synthesized by using zeolite as a sacrificial template. Zeolite-templated carbons are believed to be made of curved and single-layer graphene frameworks that exhibit a significantly uniform micropore size and relatively high surface area.

Optionally a method as described can include a step of converting hydrogen that is present in the oxygen gas, into water. A step of converting hydrogen into water can be performed catalytically, for example by contacting the oxygen gas with a metal-containing catalyst, e.g., a catalyst that is based on a transition metal such as palladium, nickel, or platinum, including transition metal oxide catalysts. One example is a palladium-containing catalyst such as palladium oxide (PdO).

Optionally a method as described can include a step of reducing a temperature of oxygen gas to a cryogenic temperature before the oxygen gas is processed by a cryogenic adsorption step. For example, a flow of oxygen gas may be cooled (i.e., “pre-cooled”) in a “pre-cooling” temperature reduction step before the oxygen gas is processed with the cryogenic adsorption step to remove impurities from the oxygen gas. The pre-cooling step may use a heat exchanger to reduce the temperature of the oxygen gas to a cryogenic temperature, such as to a temperature that is below −100 degrees Celsius, or below −120, below −130, or below −140 degrees Celsius.

The cryogenic adsorption process can be carried out using equipment that is designed for a cryogenic adsorption process as described. Useful cryogenic adsorption equipment may include a cryogenic adsorption apparatus that includes: a process chamber (or “adsorption chamber”) that includes an interior volume that contains adsorbent; a cryogenic cooling system to reduce a temperature of the interior, the oxygen gas within the interior, and the adsorbent within the interior; a control system to control a temperature of the process within the interior and to maintain a minimum temperature above a temperature which oxygen will condense; as well as appurtenant flow control structures such as pipes, valves, sensors, flow control meters, pressure meters, and the like, to guide a flow of the oxygen gas into, through, and from the adsorption chamber.

Useful or preferred cryogenic adsorption equipment can be of a type that is designed to process an oxygen gas having of very high purity, without the equipment being a source of contamination. The oxygen gas can flow through the equipment for processing, with a minimum of impurities or contaminants being introduced into the oxygen gas from the equipment. Such equipment may sometimes be referred to as ultra-high purity flow control equipment or components.

To reduce the potential of new impurities being introduced from process equipment into a flow of the oxygen gas during processing, surfaces of the process equipment may be treated to remove impurities and to reduce surface morphology that may allow for materials to be transferred from the surface to the oxygen gas that contacts the surface. Process equipment includes processing devices and flow control devices such as: a process chamber; heat-transfer surfaces; support surfaces for solid catalyst particles or solid adsorbent particles; flow control devices such as valves, baffles, conduits (e.g., piping), etc.; or any other surface that contacts a flow of the oxygen gas during processing.

In useful or preferred systems, interior surfaces of one or more process chambers, valves, flow control conduits, metering devices, sensors, etc., may be processed to a highly smooth finish to reduce a surface area of the surface at a microscopic level in a way that reduces reactivity of the surface. A useful finishing process is one that treats and renders the surface clean and less reactive, i.e., having a reduced reactivity, to ensure and maintain a high purity of the oxygen gas as the gas is processed by the system. The process of reducing reactivity of the surface may be referred to as a process of “passivating” the surface, and the processed surface may be referred to as a “passivated” surface. Examples of passivating techniques include abrasive blasting, polishing, grinding, sanding, electropolishing, electroplating, electroless plating, coating, galvanizing, anodizing, etc.

Components of a system of the present description that may be prepared for processing to avoid introducing an impurity to the oxygen gas include any surface that contacts the oxygen gas during processing. This includes any surface of a cryogenic adsorption apparatus, any surface of a heat exchanger if used in the system, any surface of equipment to catalytically convert hydrogen to water if used in the system, and any conduit (pipes), valve, sidewalls of a process chamber of a catalytic converter, or of a heat exchanger, or of a cryogenic media bed, or other devices used to monitor or control the flow of oxygen gas during a process as described.

Particular examples of useful surfaces include surfaces made of electropolished stainless steel, and surfaces made of chemically-passivated stainless steel. Electropolished stainless steel is a known type of stainless steel material having a surface that has been processed by electropolishing. An electropolishing process, also referred to as a “reverse plating” process, uses an electrochemical solution to remove a very small amount of an outer surface of a stainless steel part. By stripping away a small and uniform layer of the stainless steel surface, the electropolishing process also removes embedded contaminants, heat tint and oxide scale, burrs, micro cracks, pits, and features that may cause a transfer of a material from the stainless steel surface to oxygen gas that contacts that stainless steel surface, which becomes a contaminant in the oxygen gas. A useful electropolished surface may be one that meets ASTM B912 requirements for electropolished stainless steel.

Chemically-passivated stainless steel is also a known type of stainless steel material, having a surface that has been processed by a chemical passivation step. A chemical passivation step is a process of contacting a stainless steel surface with a liquid acid such as citric acid or nitric acid. The acid can remove free iron and other contamination from the surface, and leaves behind a passive metal oxide film at the surface. The passivation and the formed metal oxide film may be effective to inhibit the a transfer of a contaminant from the stainless steel surface to an oxygen gas that contacts that stainless steel surface. A useful chemically passivated stainless steel surface may be one that meets ASTM B912 requirements for chemically passivated stainless steel.

Also in example systems, surfaces of the equipment that will contact oxygen gas during processing may be non-lubricated. While systems may include lubrication, example systems do not contain any lubricant, even fluorinated lubricant. Certain types of flow control systems may be designated as “cleaned for oxygen service,” which means that the systems may contain fluorinated lubricant. Systems that contain fluorinated lubricant may be less preferred and may be excluded from processes as described.

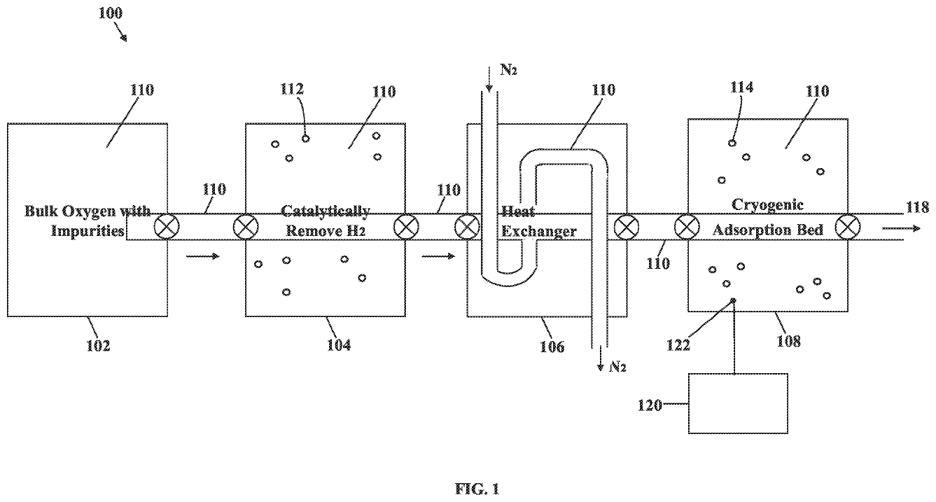

Referring to FIG. 1, system 100 is an example of a system of devices and flow control equipment that can be useful to perform the described method. At FIG. 1, system 100 includes an oxygen gas source 102, a catalytic process chamber 104, a heat exchanger 106, and cryogenic adsorption bed 108. A step of catalytically removing hydrogen using process chamber 104 is optional and may be excluded. Similarly, oxygen source 102 and heat exchanger 106 may be provided in any useful form, including but not limited to the arrangement illustrated at FIG. 1.

Referring again to FIG. 1, oxygen gas 110 is contained at oxygen gas source 102. Oxygen gas 110 may be at any temperature and pressure, e.g., at a temperature that is in a range from 0 to 40 degrees Celsius, and at a pressure of approximately atmospheric pressure.

Oxygen gas 110 flows through a valved conduit to and into catalysis process chamber 104, which contains catalyst 112, which is effective to catalytically convert hydrogen in oxygen gas 110 into water. Oxygen gas 110 flowing through apparatus 104 may be at any temperature and pressure, e.g., at a temperature that is in a range from 0 to 40 degrees Celsius, and at a pressure in a range from 17 to 140 pounds per square inch (gauge).

After catalytic process chamber 104, oxygen gas 110 flows through a valved conduit into heat exchanger (“pre-cooler”) 106, to reduce the temperature of oxygen gas 110 to a cryogenic temperature, e.g., below −100 degrees Celsius. Heat exchanger 106 includes a process chamber and a cooling conduit that passes through the process chamber. The cooling conduit contains a flow of nitrogen at a cryogenic temperature. By contacting the conduit that contains the flow of cryogenic nitrogen, the temperature of oxygen gas 110 is reduced. Oxygen gas 110 flowing through heat exchanger 106 may be at any useful pressure, e.g., a pressure in a range from 17 to 140 pounds per square inch (gauge).

From heat exchanger 106, oxygen gas 110 flows to cryogenic adsorption bed 108, which contains adsorbent 114 as described herein, such a molecular sieve adsorbent. The temperature at the interior of cryogenic adsorption bed 108 is measured by temperature sensor (e.g., thermocouple) 122, and is controlled at a cryogenic temperature by control system 120. The temperature within cryogenic adsorption bed 108 is held at a cryogenic temperature that is effective to cause impurities such as nitrogen (among others) present in oxygen gas 110 to adsorb onto surfaces of adsorbent 114. The temperature is controlled to not fall to a temperature at which oxygen will condense within cryogenic adsorption bed 108. In example methods, the temperature within cryogenic adsorption bed 108 is held above −190 degrees Celsius, such as at a temperature in a range from −190 degrees Celsius to −140 degrees Celsius, e.g., in a range from −185 or −180 degrees Celsius to −150 degrees Celsius. Purified oxygen 118 is delivered from cryogenic adsorption bed 108.

According to this system and other systems of the present description, purified oxygen (e.g., 118) may contain very low amounts of impurities such as: hydrogen (H₂), nitrogen (N₂), nitrogen oxide, water (H₂O), carbon dioxide (CO₂), carbon monoxide (CO), and hydrocarbons (CₙHₘ). The amounts of these impurities may vary based on the content of each type of impurity initially contained in the oxygen gas, before processing.

By example methods, in example systems, the amounts of one or a combination of these impurities (hydrogen (H₂), nitrogen (N₂), nitrogen oxide, water (H₂O), carbon dioxide (CO₂), carbon monoxide (CO), and hydrocarbons (CₙHₘ)) may be below 1 part per billion, e.g., below 0.5 ppb or below 0.1 ppb.

In a first aspect, disclosed is a method of purifying oxygen gas to form purified oxygen gas, the method comprising contacting the oxygen gas with adsorption media at a temperature below −100 degrees Celsius to cause a nitrogen-containing impurity that is contained in the oxygen gas to adsorb onto a surface of the adsorption media, without allowing oxygen to condense.

A second aspect according to the first aspect further comprises controlling the temperature of the oxygen gas to prevent condensation of the oxygen gas.

A third aspect according to the first aspect further comprising controlling the temperature of the oxygen gas to remain in a range from −140 degrees Celsius to −190 degrees Celsius.

In a fourth aspect according to any preceding aspect, the method is performed in a cryogenic adsorption bed that contains the adsorption media, and the cryogenic adsorption bed comprises a passivated surface.

In a fifth aspect according to the fourth aspect, the passivated surface comprises electropolished stainless steel or chemically passivated stainless steel.

A sixth aspect according to any of the preceding aspect further comprises catalytically converting hydrogen contained in the oxygen gas into water.

In a seventh aspect according to the sixth aspect, catalytically converting the hydrogen comprises contacting the oxygen gas with solid catalyst particles contained in a process chamber, and the process chamber comprises a passivated surface.

In an eighth aspect according to the seventh aspect, the passivated surface is an electropolished stainless steel surface or a chemically-passivated stainless steel surface.

In a ninth aspect according the any of the preceding aspects, contacting the oxygen gas with adsorption media comprises passing the oxygen gas through a cryogenic adsorption bed comprising: an adsorption chamber, solid adsorption media contained in the adsorption chamber, and a passivated surface.

In a tenth aspect according to the ninth aspect, the passivated surface is an electropolished stainless steel surface or a chemically passivated stainless steel surface.

In an eleventh aspect according to any of the preceding aspects, the adsorption media comprises zeolite particles or carbonaceous particles.

In a twelfth aspect according to any of the preceding aspects, the adsorption media comprises molecular sieve particles.

In a thirteenth aspect according to any of the preceding aspects, the adsorption media has pores having a pore size diameter of less than 20 angstroms.

A fourteenth aspect according to any of the preceding aspects, further comprises: pre-cooling the oxygen gas to a temperature below −100 degrees Celsius using a heat exchanger, contacting the pre-cooled oxygen gas with the adsorption media at a temperature in a range from −140 degrees Celsius to −190 degrees Celsius to cause an impurity contained in the oxygen gas to adsorb onto a surface of the adsorption media, wherein: the oxygen gas includes one or more impurities selected from a nitrogen-containing impurity (e.g., nitrogen (N₂) a nitrogen oxide (e.g., N₂O, NO, NO₂), ammonia (NH₃), and an amine), water (H₂O), carbon monoxide (CO), carbon dioxide (CO₂), methane (CH₄), a non-methane hydrocarbon (NMHC), argon (Ar), and hydrogen (H₂), and the adsorption media comprises molecular sieve particles.

In a fifteenth aspect according to any of the preceding aspects, the nitrogen-containing impurity is nitrogen (N₂) or a nitrogen oxide (e.g., N₂O, NO, NO₂)).

In a sixteenth aspect according to the fifteenth aspect, pre-cooling the oxygen gas comprises passing the gaseous oxygen through a heat exchanger that comprises a process chamber and cooling surfaces within the process chamber, and the cooling surfaces, surfaces of the process chamber, or both comprise a passivated surface.

In a seventeenth aspect according to the sixteenth aspect, the passivated surface is an electropolished stainless steel surface or a chemically-passivated stainless steel surface.

In an eighteenth aspect according to any of the previous aspects, the oxygen gas contains a maximum of 0.1 percent impurities.

In a nineteenth aspect according to any of the preceding aspects, the oxygen gas contains at least 99.9 volume percent oxygen before contacting the oxygen gas with the adsorption media.

In a twentieth aspect according to any of the preceding aspects, the oxygen gas contains less than 100 parts per million total N₂ and Ar before contacting the oxygen gas with the adsorption media.

In a twenty-first aspect according to any of the preceding aspects, the oxygen gas contains less than 30 parts per million H₂O before contacting the oxygen gas with the adsorption media.

In a twenty-second aspect according to any of the preceding aspects, the purified oxygen gas contains less than 1 part per billion N₂ after contacting the oxygen gas with adsorption media.

In a twenty-third aspect according to any of the preceding aspects, the purified oxygen gas contains less than 0.5 part per billion N₂ after contacting the oxygen gas with adsorption media.

In a twenty-fourth aspect a system for removing impurities from oxygen gas is disclosed, the system comprising: a source of oxygen gas, a cryogenic adsorption bed connected to the source of oxygen gas, the cryogenic adsorption bed comprising adsorbent particles held at a cryogenic temperature and adapted to adsorb nitrogen that is contained in the oxygen gas, without causing oxygen to condense, and a temperature control system that monitors a temperature within the cryogenic adsorption bed and controls the temperature to a setpoint above a condensation temperature of the gaseous oxygen.

In a twenty-fifth aspect according to the twenty-fourth aspect, the temperature control system is adapted to maintain the temperature above −190 degrees Celsius.

In a twenty-sixth aspect according to the twenty-fourth or twenty-fifth aspect, the cryogenic adsorption bed comprises a passivated surface.

In a twenty-seventh aspect according to the twenty-sixth aspect, the passivated surface is an electropolished stainless steel surface or a chemically passivated stainless steel surface.

A twenty-eighth aspect according to any of the twenty-fourth through twenty-seventh aspects, further comprises a catalytic process chamber comprising catalyst particles capable of converting gaseous hydrogen present in the oxygen gas into water, wherein the catalytic process chamber comprises a passivated surface.

In a twenty-ninth aspect according to the twenty-eighth aspect, the passivated surface is an electropolished stainless steel surface or a chemically passivated stainless steel surface.

A thirtieth aspect according to any of the twenty-fourth through twenty-ninth aspects, further comprises a heat exchanger connected to the cryogenic adsorption bed, the heat exchanger being capable of reducing a temperature of the oxygen gas to below −100 degrees Celsius, wherein the heat exchanger comprises a passivated surface.

In a thirty-first aspect according to the thirtieth aspect, the passivated surface is an electropolished stainless steel surface or a chemically passivated stainless steel surface.

In a thirty-second aspect according to any of the twenty-fourth through thirty-first aspects, the adsorption media comprises zeolite particles or carbonaceous particles.

In a thirty-third aspect according to any of the twenty-fourth through thirty-second aspects, the adsorption media comprises molecular sieve particles.

In a thirty-third aspect according to any of the twenty-fourth through thirty-third aspects, the adsorption media have pores having a pore size diameter of less than 20 angstroms.

1. A method of purifying oxygen gas to form purified oxygen gas, the method comprising: contacting the oxygen gas with adsorption media at a temperature below −100 degrees Celsius to cause a nitrogen-containing impurity that is contained in the oxygen gas to adsorb onto a surface of the adsorption media, without allowing oxygen to condense.

2. The method of claim 1, further comprising controlling the temperature of the oxygen gas to prevent condensation of the oxygen gas.

3. The method of claim 1, further comprising controlling the temperature of the oxygen gas to remain in a range from −140 degrees Celsius to −190 degrees Celsius.

4. The method of claim 1, wherein the method is performed in a cryogenic adsorption bed that contains the adsorption media, and the cryogenic adsorption bed comprises a passivated surface.

5. (canceled)

6. The method of claim 1, further comprising catalytically converting hydrogen contained in the oxygen gas into water.

7. The method of claim 6, wherein catalytically converting the hydrogen comprises contacting the oxygen gas with solid catalyst particles contained in a process chamber, and the process chamber comprises a passivated surface.

8. (canceled)

9. The method of claim 1, wherein contacting the oxygen gas with adsorption media comprises passing the oxygen gas through a cryogenic adsorption bed comprising: an adsorption chamber, solid adsorption media contained in the adsorption chamber, and a passivated surface.

10. (canceled)

11. The method of claim 1, wherein the adsorption media comprises zeolite particles or carbonaceous particles.

12. The method of claim 1, wherein the adsorption media comprises molecular sieve particles.

13. The method of claim 1, wherein the adsorption media has pores having a pore size diameter of less than 20 angstroms.

14. The method of claim 1, further comprising:
pre-cooling the oxygen gas to a temperature below −100 degrees Celsius using a heat exchanger,
contacting the pre-cooled oxygen gas with the adsorption media at a temperature in a range from −140 degrees Celsius to −190 degrees Celsius to cause an impurity contained in the oxygen gas to adsorb onto a surface of the adsorption media,
wherein:
the oxygen gas includes one or more impurities selected from a nitrogen-containing impurity (e.g., nitrogen (N₂) a nitrogen oxide (e.g., N₂O, NO, NO₂), ammonia (NH₃), and an amine), water (H₂O), carbon monoxide (CO), carbon dioxide (CO₂), methane (CH₄), a non-methane hydrocarbon (NMHC), argon (Ar), and hydrogen (H₂), and
the adsorption media comprises molecular sieve particles.

15. The method of claim 1 wherein the nitrogen-containing impurity is nitrogen (N₂) or a nitrogen oxide.

16. The method of claim 15, wherein:
pre-cooling the oxygen gas comprises passing the gaseous oxygen through a heat exchanger that comprises a process chamber and cooling surfaces within the process chamber, and
the cooling surfaces, surfaces of the process chamber, or both comprise a passivated surface.

17. (canceled)

18. The method of claim 1, wherein the oxygen gas contains a maximum of 0.1 percent impurities.

19. The method of claim 1, wherein the oxygen gas contains at least 99.9 volume percent oxygen before contacting the oxygen gas with the adsorption media.

20. The method of claim 1, wherein the oxygen gas contains less than 100 parts per million total N₂ and Ar before contacting the oxygen gas with the adsorption media.

21. The method of claim 1, wherein the oxygen gas contains less than 30 parts per million H₂O before contacting the oxygen gas with the adsorption media.

22. The method of claim 1, wherein the purified oxygen gas contains less than 1 part per billion N₂ after contacting the oxygen gas with adsorption media.

23. The method of claim 1, wherein the purified oxygen gas contains less than 0.5 part per billion N₂ after contacting the oxygen gas with adsorption media.

24. A system for removing impurities from oxygen gas, the system comprising:
a source of oxygen gas,
a cryogenic adsorption bed connected to the source of oxygen gas, the cryogenic adsorption bed comprising adsorbent particles held at a cryogenic temperature and adapted to adsorb nitrogen that is contained in the oxygen gas, without causing oxygen to condense, and
a temperature control system that monitors a temperature within the cryogenic adsorption bed and controls the temperature to a setpoint above a condensation temperature of the gaseous oxygen.

25. The system of claim 24, wherein the temperature control system is adapted to maintain the temperature above −190 degrees Celsius.

26. The system of claim 24, wherein the cryogenic adsorption bed comprises a passivated surface.

27. (canceled)

28. The system of claim 24, comprising a catalytic process chamber comprising catalyst particles capable of converting gaseous hydrogen present in the oxygen gas into water, wherein the catalytic process chamber comprises a passivated surface.

29. (canceled)

30. The system of claim 24, further comprising a heat exchanger connected to the cryogenic adsorption bed, the heat exchanger being capable of reducing a temperature of the oxygen gas to below −100 degrees Celsius, wherein the heat exchanger comprises a passivated surface.

31. (canceled)

32. The system of claim 24, wherein the adsorption media comprises zeolite particles or carbonaceous particles.

33. The system of claim 24, wherein the adsorption media comprises molecular sieve particles.

34. The system of claim 24, wherein the adsorption media have pores having a pore size diameter of less than 20 angstroms.
